(19) United States
(12) Patent Application Publication
(10) Pub. No.: US 2025/0189362 A1
(43) Pub. Date: Jun. 12, 2025

(54) ANALYSIS DEVICE, ANALYSIS METHOD, AND PROGRAM

(71) Applicant: MITSUBISHI HEAVY INDUSTRIES, LTD., Tokyo (JP)

(72) Inventors: Akihisa IWASAKI, Tokyo (JP); Naoki GOTO, Tokyo (JP)

(73) Assignee: MITSUBISHI HEAVY INDUSTRIES, LTD., Tokyo (JP)

(21) Appl. No.: 18/843,834

(22) PCT Filed: Mar. 7, 2023
(86) PCT No.: PCT/JP2023/008558

§ 371 Date: Sep. 4, 2024

(30) Foreign Application Priority Data
Mar. 9, 2022 (JP) 2022-036498

(51) Int. Cl. G01H 9/00; G06T 5/50

(52) U.S. Cl. CPC G01H 9/00; G06T 5/50; G06T 2207/20221

(57) ABSTRACT

An analysis device includes: a vibration image generation unit configured to generate, based on an image in which an inspection target is photographed, a vibration image visualizing a vibration level per region of the inspection target on the image at a first natural vibration frequency at which a peak of the vibration level appears; a sound source image generation unit configured to generate, based on recorded sound data of the inspection target recorded simultaneously with the image, a sound source image visualizing a sound pressure level per region on the image; an extraction unit configured to extract the first natural vibration frequency included within a predetermined range from a second natural vibration frequency at which a peak of the sound pressure level of the noise appears; and an analysis image generation unit configured to generate an analysis image in which the vibration image corresponding to the first natural vibration frequency extracted and the sound source image are superimposed.

### TECHNICAL FIELD

The present disclosure relates to an analysis device, an analysis method, and a program.

The present application claims priority based on JP 2022-036498 filed in Japan on Mar. 9, 2022, the contents of which are incorporated herein by reference.

### BACKGROUND ART

A technique for grasping a state of an inspection target from a photographed image (video) of a structure, a machine, or the like which is the inspection target has been studied.

For example. Patent Document 1 describes a technique for inspecting a state of a structure such as a bridge by measuring an in-plane displacement of the structure from a photographed image of the structure.

In addition, a technique for measuring a vibration state (a position where vibration occurs, a magnitude of the vibration, and the like) of an inspection target from a photographed image has been studied.

### CITATION LIST

### Patent Literature

Patent Document 1: WO 2020/255231

### SUMMARY OF INVENTION

### Technical Problem

The inspection target may generate a noise due to a vibration.

In order to appropriately take measures to suppress the noise, it is necessary to identify the vibration causing the noise.

The present disclosure has been made in view of such a problem, and provides an analysis device, an analysis method, and a program capable of visualizing a correlation between a vibration and a noise of an inspection target.

### Solution to Problem

According to an aspect of the present disclosure, an analysis device includes: a vibration image generation unit configured to acquire, based on an image in which an inspection target is photographed, vibration information including a time series of a vibration level of the inspection target and a distribution of the vibration level for an individual vibration frequency and generate a vibration image visualizing the vibration level per region of the inspection target on the image at a first natural vibration frequency at which a peak of the vibration level appears; a sound source image generation unit configured to acquire, based on recorded sound data of the inspection target recorded simultaneously with the image, noise information including a time series of a sound pressure level of a noise generated from the inspection target and a distribution of the sound pressure level for an individual vibration frequency and generate a sound source image visualizing the sound pressure level per region on the image; an extraction unit configured to extract, based on the vibration information and the noise information, the first natural vibration frequency included within a predetermined range from a second natural vibration frequency at which a peak of the sound pressure level of the noise appears; and an analysis image generation unit configured to generate an analysis image in which the vibration image corresponding to the first natural vibration frequency extracted and the sound source image are superimposed.

According to an aspect of the present disclosure, an analysis method includes: acquiring, based on an image in which an inspection target is photographed, vibration information including a time series of a vibration level of the inspection target and a distribution of the vibration level for an individual vibration frequency and generating a vibration image visualizing the vibration level per region of the inspection target on the image at a first natural vibration frequency at which a peak of the vibration level appears; acquiring, based on recorded sound data of the inspection target recorded simultaneously with the image, noise information including a time series of a sound pressure level of a noise generated front the inspection target and a distribution of the sound pressure level for the individual vibration frequency and generating a sound source image visualizing the sound pressure level per region on the image; extracting, based on the vibration information and the noise information, the first natural vibration frequency included within a predetermined range from a second natural vibration frequency at which a peak of the sound pressure level of the noise appears; and generating an analysis image in which the vibration image corresponding to the first natural vibration frequency extracted and the sound source image are superimposed.

According to an aspect of the present disclosure, a program causes an analysis device to execute: acquiring, based on an image in which an inspection target is photographed, vibration information including a time series of a vibration level of the inspection target and a distribution of the vibration level for an individual vibration frequency and generating a vibration image visualizing the vibration level per region of the inspection target on the image at a first natural vibration frequency at which a peak of the vibration level appears; acquiring, based on recorded sound data of the inspection target recorded simultaneously with the image, noise information including a time series of a sound pressure level of a noise generated from the inspection target and a distribution of the sound pressure level for the individual vibration frequency and generating a sound source image visualizing the sound pressure level per region on the image; extracting, based on the vibration information and the noise information, the first natural vibration frequency included within a predetermined range from a second natural vibration frequency at which a peak of the sound pressure level of the noise appears; and generating an analysis image in which the vibration image corresponding to the first natural vibration frequency extracted and the sound source image are superimposed.

### Advantageous Effects of Invention

According to the analysis device, the analysis method, and the program according to the present disclosure, it is possible to visualize a correlation between a sound source of a noise and a vibration of an inspection target.

### BRIEF DESCRIPTION OF DRAWINGS

FIG. 1 is a diagram illustrating an overall configuration of an analysis system according to a first embodiment of the present disclosure.

FIG. 2 is a block diagram illustrating a functional configuration of an analysis device according to the first embodiment of the present disclosure.

FIG. 3 is a flowchart illustrating an example of processing of the analysis device according to the first embodiment of the present disclosure.

FIG. 4 is a diagram illustrating an example of a vibration image according to the first embodiment of the present disclosure.

FIG. 5 is a diagram illustrating an example of a sound source image according to the first embodiment of the present disclosure.

FIG. 6 is a first diagram for explaining a function of the analysis device according to the first embodiment of the present disclosure.

FIG. 7 is a second diagram for explaining a function of the analysis device according to the first embodiment of the present disclosure.

FIG. 8 is a diagram illustrating an example of an analysis image according to the first embodiment of the present disclosure.

FIG. 9 is a first diagram for explaining a function of an analysis device according to a second embodiment of the present disclosure.

FIG. 10 is a second diagram for explaining a function of the analysis device according to the second embodiment of the present disclosure.

FIG. 11 is a first diagram for explaining a function of an analysis device according to a third embodiment of the present disclosure.

FIG. 12 is a second diagram for explaining a function of the analysis device according to the third embodiment of the present disclosure.

### DESCRIPTION OF EMBODIMENTS

### First Embodiment

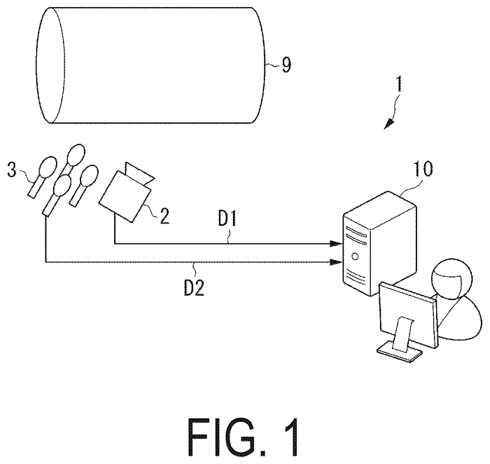

Hereinafter, an analysis system 1 and an analysis device 10 according to a first embodiment of the present disclosure will be described with reference to FIG. 1 to FIG. 8.

### Overall Configuration

FIG. 1 is a diagram illustrating an overall configuration of the analysis system according to the first embodiment of the present disclosure.

The analysis system 1 is a system for measuring a vibration and a noise of an inspection target 9 and outputting an analysis image in which a position of a sound source of the noise can be specified and a mechanism of the noise (vibration or the like causing the noise) can be visually confirmed.

The inspection target 9 is, for example, a rotary machine such as a motor and a gas turbine.

FIG. 1 illustrates an example in which the inspection target 9 is a rotor shaft of a rotary machine.

In another embodiment, the inspection target 9 may be a rotary blade of a gas turbine or a structure such as a pipe.

As illustrated in FIG. 1, the analysis system 1 includes a camera 2, a plurality of microphones 3, and the analysis device 10.

The camera 2 captures an image of the inspection target 9.

An image D1 (video) photographed by the camera 2 is transmitted to the analysis device 10.

Each of the plurality of microphones 3 records sound (noise) emitted by the inspection target 9.

Recorded sound data D2 recorded by each of the microphones 3 is transmitted to the analysis device 10.

The analysis device 10 generates an analysis image visualizing a state of the vibration and the noise of the inspection target 9 based on the image D1 and the recorded sound data D2.

### Functional Configuration of Analysis Device

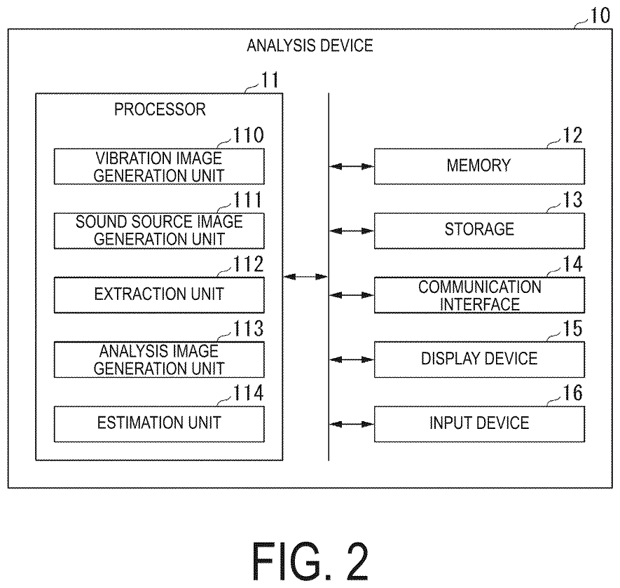

FIG. 2 is a block diagram illustrating a functional configuration of the analysis device according to the first embodiment of the present disclosure.

As illustrated in FIG. 2, the analysis device 10 includes a processor 11, a memory 12, a storage 13, a communication interface 14, a display device 15, and an input device 16.

The processor 11 functions as a vibration image generation unit 110, a sound source image generation unit 111, an extraction unit 112, an analysis image generation unit 113, and an estimation unit 114 by operating in accordance with a predetermined program.

The vibration image generation unit 110 acquires vibration information including a time series of a vibration level of the inspection target 9 and a distribution of vibration level for each vibration frequency based on the image D1 obtained by photographing the inspection target 9.

In addition, the vibration image generation unit 110 generates a vibration image visualizing a vibration level for each region of the inspection target on the image D1 at a first natural vibration frequency at which a peak of the vibration level appears.

The sound source image generation unit 111 acquires noise information including a time series of a sound pressure level of a noise generated from the inspection target 9 and a distribution of sound pressure level for each frequency based on the recorded sound data D2 of the inspection target 9 recorded simultaneously with the image D1.

In addition, the sound source image generation unit 111 generates a sound source image visualizing a sound pressure level for each region on the image D1.

The extraction unit 112 extracts a first natural vibration frequency included in a predetermined range from a second natural vibration frequency at which a peak of a sound pressure level of the noise appears, based on the vibration information and the noise information.

The analysis image generation unit 113 generates an analysis image in which the vibration image corresponding to the first natural vibration frequency extracted by the extraction unit 112 and the sound source image are superimposed.

The estimation unit 114 estimates a vibration causing the noise based on the analysis image.

The predetermined program executed by the processor 11 is stored in a computer-readable recording medium.

The computer-readable recording medium refers to a magnetic disk, a magneto-optical disk, a CD-ROM, a DVD-ROM, a semiconductor memory, and the like.

The computer program may be distributed to a computer via a communication line, and the computer having received the distribution may execute the program.

Further, the program may be a program for implementing a part of the above-described functions.

Furthermore, the program may be a so-called differential file (differential program) that can implement the above-described functions in combination with a program already recorded in a computer system.

The memory 12 has a memory area necessary for the operation of the processor 11.

The storage 13 is a so-called auxiliary storage device, and is, for example, a hard disk drive (HDD) or a solid state drive (SSD).

The communication interface 14 is an interface for transmitting and receiving various signals to and from external devices (the camera 2, the microphones 3, and the like).

The display device 15 is a display device that displays an analysis image and the like, and is, for example, a liquid crystal display or an organic EL display.

The input device 16 is an input device that receives an operation by the user of the analysis device 10, and is, for example, a mouse, a keyboard, or a touch sensor commonly used.

### Processing Flow of Analysis Device

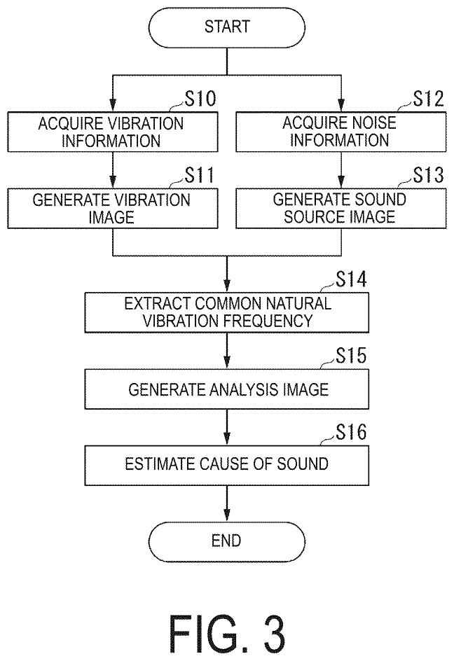

FIG. 3 is a flowchart illustrating an example of processing of the analysis device according to the first embodiment of the present disclosure.

Hereinafter, an example of processing in which the analysis device 10 generates an analysis image for analyzing a sound source position and a cause of a noise will be described with reference to FIG. 3.

First, the vibration image generation unit 110 acquires vibration information based on the image D1 of the inspection target 9 photographed by the camera 2 (step S10).

The vibration information includes a time series of a vibration level for each region (for example, for each pixel) on the image D1 and a distribution of vibration level for each vibration frequency.

First, the vibration image generation unit 110 performs known image processing on the image D1 so as to acquire a vibration level indicating a displacement amount of the inspection target 9 in each pixel of the image D1.

In addition, the vibration image generation unit 110 performs a frequency analysis (for example, fast Fourier transform) on the time series of vibration level to acquire a frequency spectrum representing the distribution of vibration level for each vibration frequency.

The vibration image generation unit 110 detects a first natural vibration frequency at which a vibration level reaches a peak based on the frequency spectrum.

In addition, the vibration image generation unit 110 generates a vibration image visualizing a vibration level for each region on the image D1 at the first natural vibration frequency (step S11).

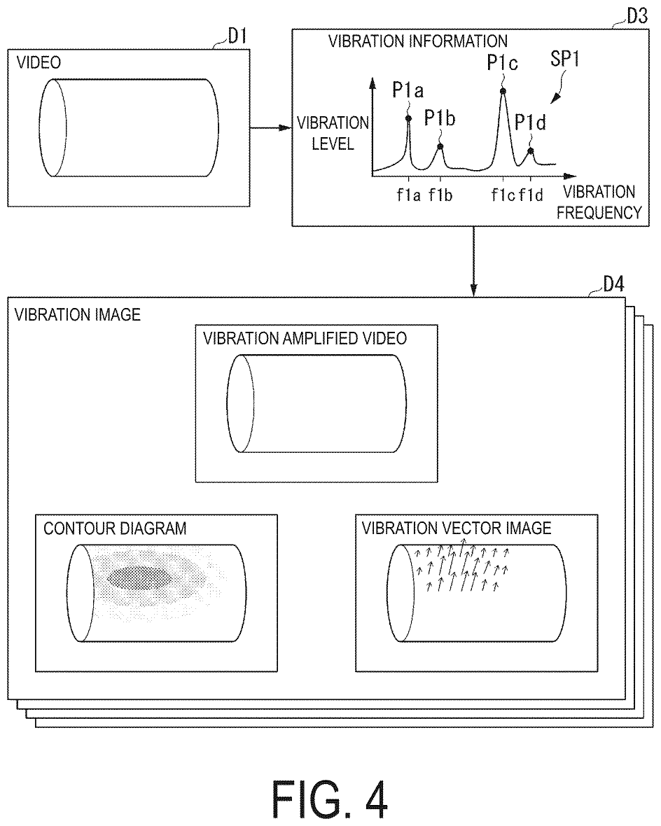

FIG. 4 is a diagram illustrating an example of the vibration image according to the first embodiment of the present disclosure.

As illustrated in FIG. 4, the vibration image generation unit 110 detects a peak of a vibration level based on a frequency spectrum SP1 included in vibration information D3 acquired from the image D1.

In the example of FIG. 4, four peaks P1a, P1b, P1c, and P1d appear in the frequency spectrum SP1.

Frequencies f1a, f1b, f1c, and f1d corresponding to these peaks are first natural vibration frequencies indicating vibration modes of the inspection target 9.

The vibration image generation unit 110 generates a vibration image D4 for each of the first natural vibration frequencies f1a, f1b, f1c, and f1d.

For example, the vibration image D4 is a video obtained by performing image processing (vibration amplification processing) on the image D1 so as to amplify the displacement amount of each pixel by X times.

As a result, the vibration image generation unit 110 can obtain a vibration image in which a state of vibration (the vibration level of each pixel) at each time can be visually recognized even when minute vibration that is difficult to detect with the naked eye occurs in the inspection target 9.

The vibration image D4 may be a contour diagram representing a distribution of vibration level at first natural vibration frequencies.

Further, the vibration image D4 may be a vibration vector image in which a vector representing the direction and magnitude of vibration in each pixel at a first natural vibration frequency is drawn.

The sound source image generation unit 111 acquires noise information based on the recorded sound data D2 recorded by each of the plurality of microphones 3 (step S12).

The noise information includes a time series of a sound pressure level for each region (for each pixel) on the image D1 and a distribution of sound pressure level for each vibration frequency.

Specifically, the sound source image generation unit 111 acquires the time series of sound pressure level of a noise in each pixel on the image D1 based on a sound pressure difference, a time difference, and the like of the noise recorded in each recorded sound data.

In addition, the sound source image generation unit 111 performs a frequency analysis (for example, fast Fourier transform) on the time series of sound pressure level to acquire a frequency spectrum representing a distribution of sound pressure level for each vibration frequency.

The recorded sound data D2 is recorded simultaneously with the image D1.

A trigger signal indicating an analysis start timing may be recorded in the image D1 and the recorded sound data D2.

In that case, the sound source image generation unit 111 synchronizes the image D1 and the recorded sound data D2 based on the trigger signal.

The sound source image generation unit 111 detects a second natural vibration frequency at which a vibration level reaches a peak based on the frequency spectrum.

In addition, the sound source image generation unit 111 generates a sound source image visualizing a sound pressure level for each region of on the image D1 at the second natural vibration frequency (step S13).

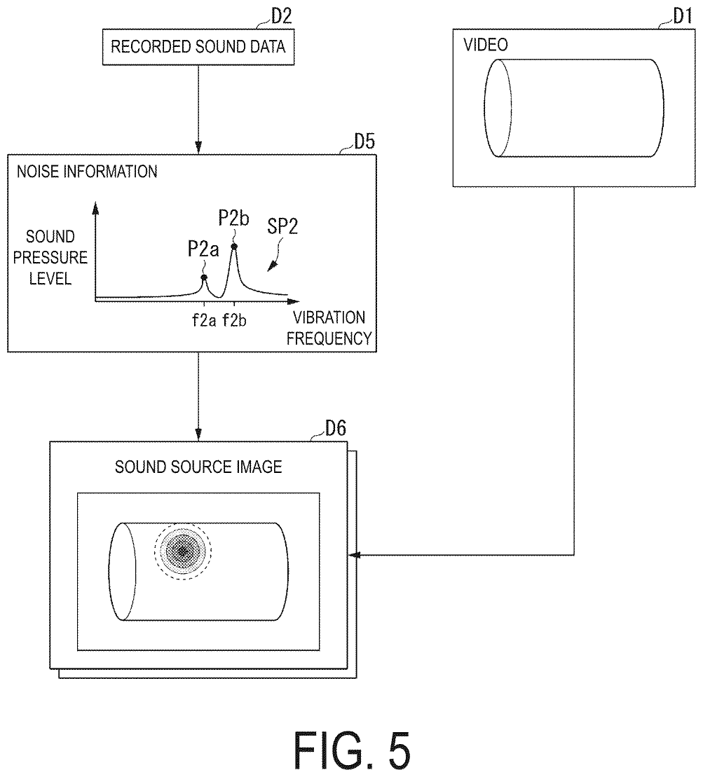

FIG. 5 is a diagram illustrating an example of the sound source image according to the first embodiment of the present disclosure.

As illustrated in FIG. 5, the sound source image generation unit III detects a peak of a sound pressure level based on a frequency spectrum SP2 included in noise information D5 acquired from the recorded sound data D2.

In the example of FIG. 5, two peaks P2a and P2b appear in the frequency spectrum SP2.

Frequencies f2a and f2b corresponding to these peaks are second natural vibration frequencies related to the noise of the inspection target 9.

The sound source image generation unit 111 generates a sound source image D6 for each of the second natural vibration frequencies f2a and f2b.

The sound source image D6 is, for example, a contour diagram representing a distribution of sound pressure level at the second natural vibration frequencies.

Next, the extraction unit 112 extracts natural vibration frequencies that substantially match between a structural system and an acoustic system based on the vibration information D3 and the noise information D5.

Specifically, the extraction unit 112 compares the frequency spectra SP1 and SP2 of the vibration and the noise, and extracts natural vibration frequencies at which peaks of both a vibration level and a sound pressure level appear (step S15).

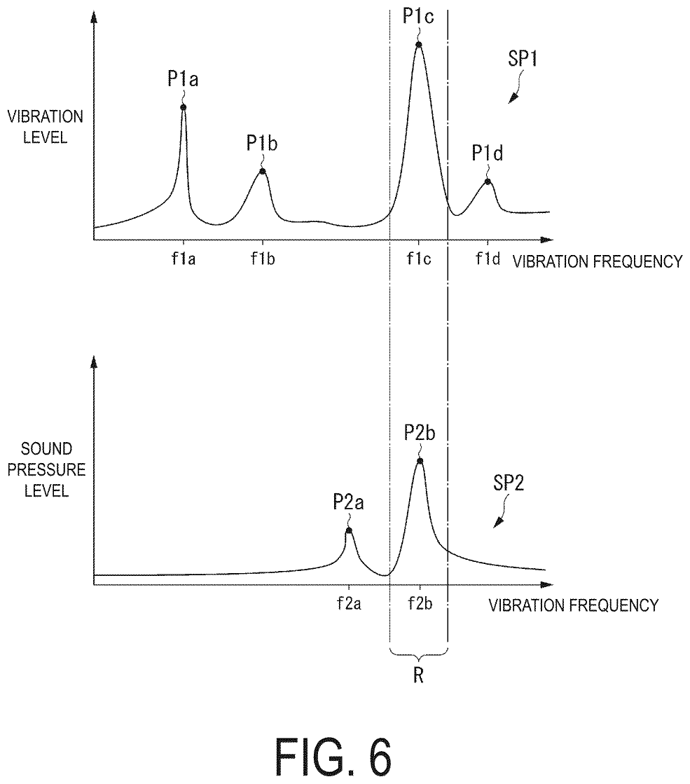

FIG. 6 is a first diagram for explaining a function of the analysis device according to the first embodiment of the present disclosure.

According to the frequency spectrum SP1 of the vibration illustrated in FIG. 6, the first natural vibration frequencies at which the peaks P1a to P1d of the vibration level appear are the frequencies f1a to f1d.

In addition, according to the frequency spectrum SP2 of the noise illustrated in FIG. 6, the second natural vibration frequencies at which the peaks P2a and P2b of the sound pressure level appear are the frequencies f2a and f2b.

The extraction unit 112 extracts, from among a plurality of first natural vibration frequencies, a first natural vibration frequency included within a predetermined range from a second natural vibration frequency of the noise as a natural vibration frequency at which the vibration level and the sound pressure level are increased in common.

In the example of FIG. 6, only one first natural vibration frequency f1c at which the peak P1c of the vibration level appears is included within a predetermined range R around the second natural vibration frequency f2b.

In this case, the extraction unit 112 extracts the first natural vibration frequency f1c.

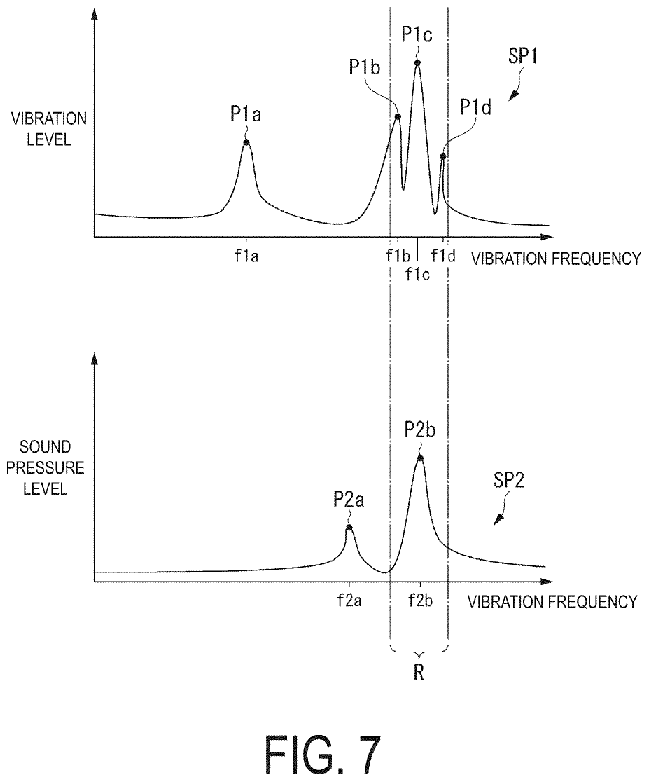

FIG. 7 is a second diagram for explaining a function of the analysis device according to the first embodiment of the present disclosure.

In the example of FIG. 7, a plurality of peaks P1b, P1c, and P1d of the vibration level appears within the predetermined range R around the second natural vibration frequency f2b.

In this case, the extraction unit 112 extracts a plurality of first natural vibration frequencies f1b, f1c, and f1d corresponding to the peaks P1b, P1c, and P1d.

In the examples of FIG. 6 and FIG. 7, no peak of the vibration level appears within the predetermined range from the second natural vibration frequency f2a at which the peak P2a of the sound pressure level appears.

In this case, the extraction unit 112 determines that the noise indicated by the peak P2a has no correlation with the vibration (for example, the noise is a sound not related to the vibration such as a wind noise), and extracts not first natural vibration frequency with respect to the second natural vibration frequency f2a.

Next, the analysis image generation unit 113 generates an analysis image in which the sound source image D6 is superimposed on the vibration image D4 corresponding to the first natural vibration frequency extracted by the extraction unit 112 (step S15).

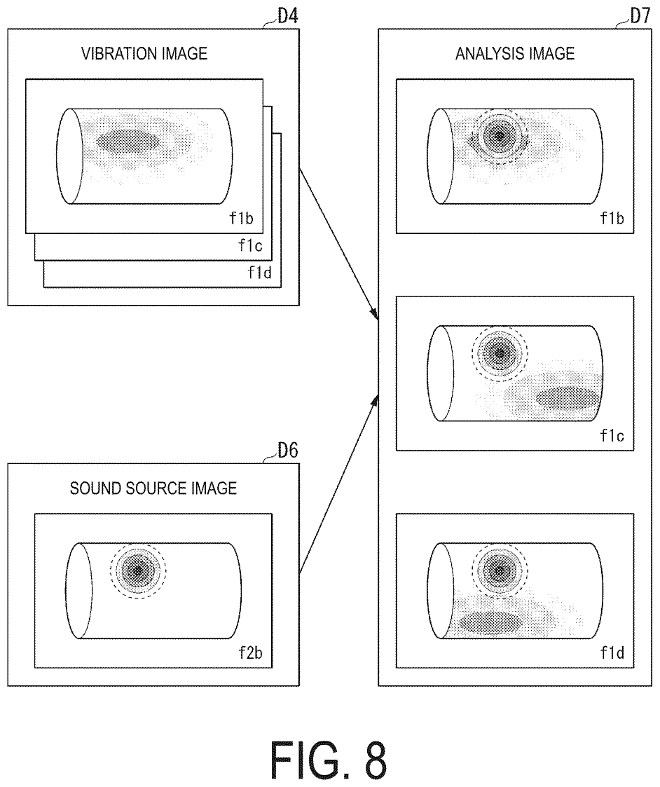

FIG. 8 is a diagram illustrating an example of the analysis image according to the first embodiment of the present disclosure.

When only one first natural vibration frequency is extracted in step S14, the analysis image generation unit 113 generates one analysis image D7 in which the sound source image D6 is superimposed on the vibration image D4 corresponding to this first natural vibration frequency.

When a plurality of first natural vibration frequencies is extracted in step S14 as in the examples of FIG. 7 and FIG. 8, the analysis image generation unit 113 generates a plurality of analysis images D7 in which the sound source image D6 is superimposed on each of the vibration images D4 corresponding to the first natural vibration frequencies.

In the example of FIG. 8, contour diagrams are used as the vibration images D4, but the present invention is not limited thereto.

In another embodiment, a vibration-amplified video or a vibration vector image may be used as the vibration image D4.

The analysis image generation unit 113 displays the generated analysis image D7 on the display device 15.

The user of the analysis device 10 can check a sound source position of a noise and a vibration causing the noise by reference to the analysis image D7 displayed on the display device 15.

When the analysis image generation unit 113 has generated a plurality of analysis images D7, the analysis image generation unit 113 may display the analysis images D7 side by side on the display device 15 so as to enable comparison therebetween, or may switch and display the analysis images D7 in accordance with an operation by the user of the analysis device 10.

In addition, the analysis image generation unit 113 may display information such as the frequency spectra SP1 and SP2 of the vibration and the noise, and the first natural vibration frequency and the second natural vibration frequency used for the analysis image D7, together with the analysis image D7.

As in the example of FIG. 7, when there is a plurality of first natural vibration frequencies f1b, f1c, and f1d close to the second natural vibration frequency f2b, it is difficult to determine vibration of which first natural vibration frequency (vibration mode) is a cause of the noise indicated by the second natural vibration frequency f2b.

However, as illustrated in FIG. 8, superimposing the sound source image D6 on the vibration image D4 of each of the first natural vibration frequencies f1b, f1c, and f1d makes it easy to compare a position where the vibration in each vibration mode is generated with a sound source position of the noise.

In the example of FIG. 8, the position where the vibration at the first natural vibration frequency f1b of the three first natural vibration frequencies is generated substantially coincides with the sound source position of the noise (the position where the sound pressure level is largest).

Further, the positions where vibration is generated at the other first natural vibration frequencies f1c and f1d are away from the sound source position of the noise.

Thus, the user of the analysis device 10 can estimate that the noise is caused by the vibration at the first natural vibration frequency f1b.

A vibration sometimes propagates from a vibration position (vibration generation source) to another place to generate a noise from a place away from the vibration position.

In consideration of such a case, for example, the analysis image generation unit 113 may perform correlation analysis of vibration data between two points of one vibration and another vibration for each of a plurality of vibrations represented by the first natural vibration frequencies extracted by the extraction unit 112, and display the analysis result together with the analysis image D7.

The user refers to the analysis result of the correlation analysis between the vibrations together with the analysis image D7 and selects one or a plurality of vibrations estimated as the cause of the noise.

For example, in the analysis image D7 illustrated in FIG. 8, it is assumed that the vibration position of the first natural vibration frequency f1b substantially coincides with the sound source position of the noise, and the correlation between the first natural vibration frequency f1b and the first natural vibration frequency fc is larger than a preset value.

In this case, the user estimates that the two vibrations of the first natural vibration frequency f1b and the first natural vibration frequency f1c are candidates for the cause of the noise based on the analysis image D7 and the analysis result of the correlation analysis.

In addition, the estimation of the cause of noise generation may be automatically performed by the analysis device 10 instead of being performed by the user viewing the analysis image D7.

Specifically, the estimation unit 114 compares regions (pixels) in each analysis image D7 in which the sound pressure level and the vibration level are largest, and estimates whether or not the vibration at the first natural vibration frequency indicated in each analysis image D7 is the cause of the noise.

When a distance between a region (sound source position) where the sound pressure level is largest and a region (vibration position) where the vibration level is largest in the analysis image D7 is equal to or less than a threshold value, the estimation unit 114 estimates that the vibration at the first natural vibration frequency indicated in the analysis image D7 is the cause of the noise.

On the other hand, when the distance between the sound source position and the vibration position exceeds the threshold value, it is estimated that the vibration indicated in the analysis image D7 is not the cause of the noise.

The region where the sound pressure level is largest is a region where the maximum value of the sound pressure level is detected or a region where a value to X % (for example, 90%) of the maximum value of the sound pressure level is detected.

The same applies to the region where the vibration level is largest.

In addition, when the analysis image generation unit 113 performs correlation analysis of each vibration with another vibration, the estimation unit 114 may further estimate a vibration causing the noise based on the analysis result.

For example, in the analysis image D7 illustrated in FIG. 8, it is assumed that the vibration position of the first natural vibration frequency f1b substantially coincides with the sound source position of the noise, and the correlation between the first natural vibration frequency f1b and the first natural vibration frequency f1c is larger than a preset value.

In this case, the estimation unit 114 may estimate that the two vibrations represented by the first natural vibration frequency f1b and the first natural vibration frequency f1c are candidates for the cause of the noise based on the analysis image D7 and the analysis result of the correlation analysis.

Accordingly, when a noise is generated at a position away from a vibration position, it is possible to prevent this vibration position from being excluded from the candidates for the cause of the noise.

The estimation unit 114 displays the analysis image D7 indicating the vibration estimated as the cause of the noise on the display device 15 together with the estimation result.

When the estimation unit 114 has determined that a distance between the sound source position and the vibration position is equal to or less than the threshold value for a plurality of analysis images D7, the estimation unit 114 may estimate the plurality of vibrations indicated by the analysis images D7 as the candidates for the cause of the noise.

In that case, the estimation unit 114 may display the plurality of estimation results and the analysis images D7 on the display device 15 to prompt the user to confirm.

By narrowing down and displaying the candidates in this way, the user can reduce the time and effort for checking all the analysis images D7.

### Operational Effects

As described above, the analysis device 10 according to the present embodiment includes: the vibration image generation unit 110 that generates the vibration image D4 visualizing a vibration level for each region of the inspection target 9; the sound source image generation unit 111 that generates the sound source image D6 visualizing a sound pressure level for each region of the inspection target 9; the extraction unit 112 that extracts a first natural vibration frequency at which peaks of the vibration level and the sound pressure level appear in common; and the analysis image generation unit 113 that generates an analysis image in which the vibration image D4 corresponding to the extracted first natural vibration frequency and the sound source image D6 are superimposed.

With such a configuration, the analysis device 10 can provide the user with the analysis image D7 in which the correlation between the intensities of a vibration and a noise, the correlation between a vibration position and a sound source position of the noise, and the like can be visually recognized.

In addition, since the user can easily estimate a vibration causing the noise with reference to the analysis image D7, the user can appropriately take measures against the noise at an early stage.

Further, the extraction unit 112 extracts a plurality of first natural vibration frequencies included within a predetermined range from the second natural vibration frequency, and the analysis image generation unit 113 generates a plurality of analysis images D7 corresponding to the respective plurality of first natural vibration frequencies.

Accordingly, when there is a plurality of vibration modes (first natural vibration frequencies) close to the second natural vibration frequency of the noise, the analysis device 10 can generate the analysis image D7 of each vibration mode.

In addition, even when only one vibration causing a noise cannot be selected from the natural vibration frequencies, the user can accurately estimate a vibration causing the noise by confirming the correlation between the vibration position and the sound source position of the noise in the analysis image D7.

The analysis device 10 further includes the estimation unit 114 that automatically estimates a vibration causing the noise based on the analysis image D7.

Accordingly, the analysis device 10 can enable the user to recognize a vibration estimated as the cause of the noise.

In addition, even when a plurality of analysis images D7 is generated, the analysis device 10 can present provide the user with the analysis image D7 corresponding to the vibration estimated as the cause, whereby the user can reduce the time and effort for checking all the analysis images D7.

When a distance between the vibration position and the sound source position in the analysis image D7 is equal to or less than a threshold value, the estimation unit 114 estimates that the vibration at the first natural vibration frequency indicated in the analysis image D7 is the cause of the noise.

Further, when the distance between the vibration position and the sound source position in the analysis image D7 exceeds the threshold value, the estimation unit 114 estimates that the vibration at the first natural vibration frequency indicated in the analysis image D7 is not the cause of the noise.

Accordingly, the analysis device 10 can accurately estimate whether or not the vibration in each analysis image D7 is the cause of the noise from the correlation between the vibration position and the sound source position indicated in the analysis image.

### Second Embodiment

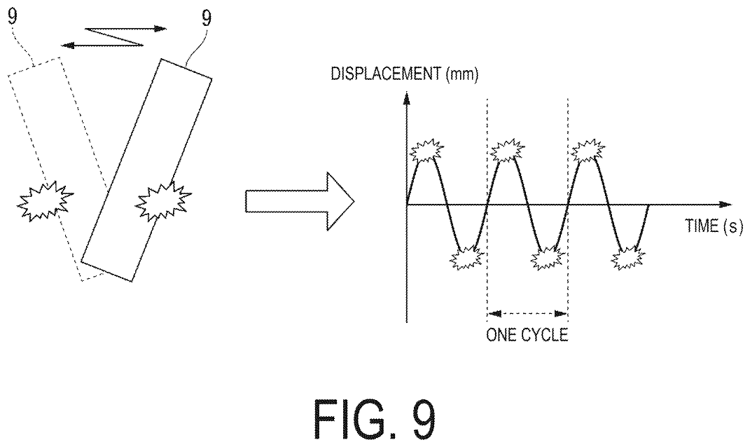

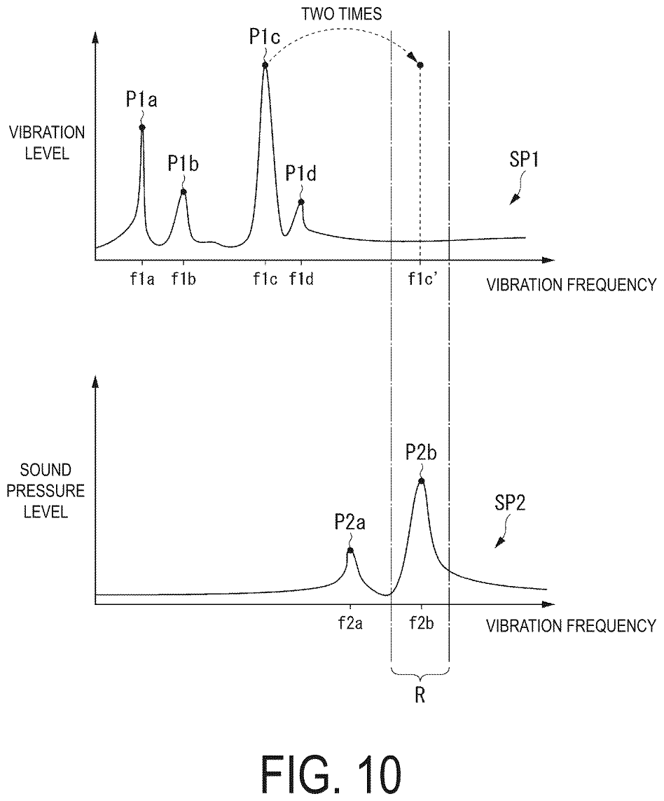

Next, the analysis system 1 and the analysis device 10 according to a second embodiment of the present disclosure will be described with reference to FIG. 9 and FIG. 10.

The same components as those in the first embodiment are denoted by the same reference signs, and detailed description thereof will be omitted.

In the first embodiment, an aspect in which the extraction unit 112 extracts a first natural vibration frequency included within a predetermined range from a second natural vibration frequency of a noise has been described.

On the other hand, according to the present embodiment, when a vibration frequency which is a predetermined multiple (n times) of a first natural vibration frequency is included within a predetermined range from a second natural vibration frequency, the extraction unit 112 further extracts this first natural vibration frequency.

FIG. 9 is a first diagram for explaining a function of the analysis device according to the second embodiment of the present disclosure.

As illustrated in FIG. 9, the inspection target 9 may collide with structures on both sides due to vibration and generate a noise.

At this time, the noise is generated twice during one period of a vibration (one period of a first natural vibration frequency).

That is, the noise is generated at a frequency twice as high as the first natural vibration frequency of the vibration.

FIG. 10 is a second diagram for explaining a function of the analysis device according to the second embodiment of the present disclosure.

FIG. 10 illustrates frequency spectra SP1 and SP2 of the vibration and the noise illustrated in FIG. 9.

In the example of FIG. 10, it is assumed that a vibration frequency f1c′ which is twice a first natural vibration frequency f1c at which a peak P1c of a plurality of peaks of the vibration level appears is included within a predetermined range R of a second natural vibration frequency f2b of the noise.

Further, it is assumed that other first natural vibration frequencies f1a, f1b, and f1d are not included within the predetermined range R of the second natural vibration frequency even when multiplied by n.

In this case, the extraction unit 112 extracts only the first natural vibration frequency f1c as a natural vibration frequency correlated with the second natural vibration frequency f2b of the noise.

Accordingly, the analysis device 10 can generate the analysis image D7 representing a candidate for the vibration causing the noise.

### Third Embodiment

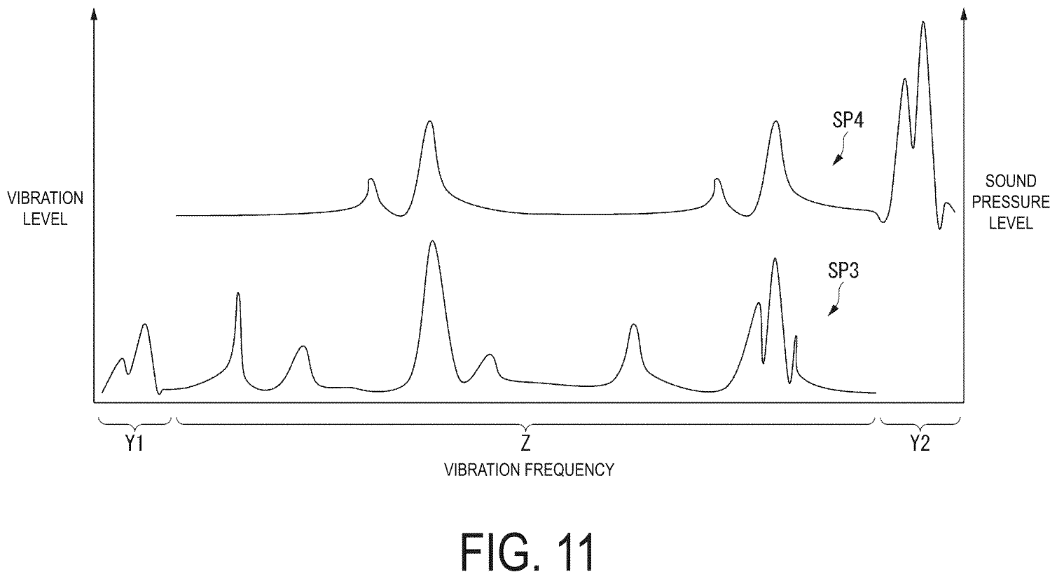

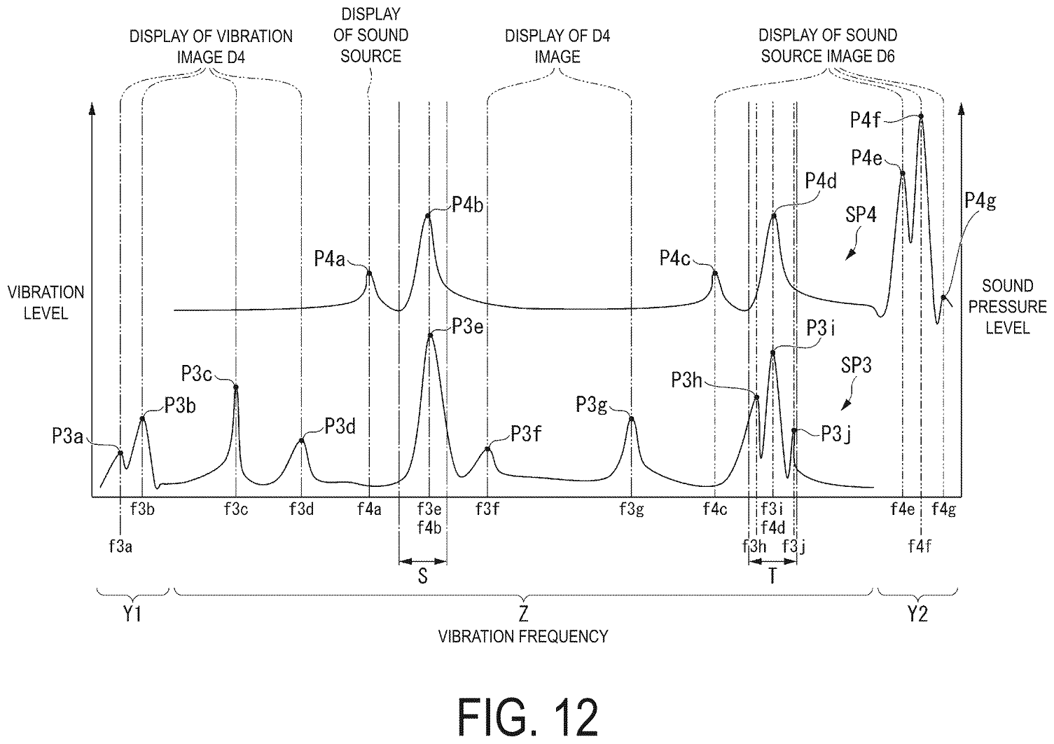

Next, the analysis system 1 and the analysis device 10 according to a third embodiment of the present disclosure will be described with reference to FIG. 11 and FIG. 12.

The same components as those in the first embodiment are denoted by the same reference signs, and detailed description thereof will be omitted.

In the first embodiment, it has been described that one analysis image D7 in which the sound source image D6 is superimposed on the vibration image D4 corresponding to a first natural vibration frequency is generated.

In addition, it has been described that when there is a plurality of first natural vibration frequencies, the analysis image generation unit 113 generates a plurality of analysis images D7 in which the sound source image D6 is superimposed on each of the vibration images D4 corresponding to the first natural vibration frequencies.

In the second embodiment, it has been described that the analysis device 10 can generate the analysis image D7 representing a candidate for the vibration causing the noise in consideration of the possibility that the noise is generated in a period which is n times the vibration.

On the other hand, in the present embodiment, the analysis image generation unit 113 superimposes and displays the frequency spectra of a vibration and a noise used in creating an analysis image, and displays the analysis image related to peaks of a frequency spectrum designated by the user.

FIG. 11 is a first diagram for explaining a function of the analysis device according to the third embodiment of the present disclosure.

As illustrated in FIG. 11, the analysis image generation unit 113 displays a frequency spectrum in which a frequency spectrum SP3 of a vibration included in the vibration information D3 acquired from the image D1 and a frequency spectrum SP4 of a noise included in the noise information D5 acquired from the recorded sound data D2 are superimposed, where the horizontal axis represents vibration frequency, the first vertical axis represents vibration level, and the second vertical axis represents sound pressure level.

Note that the display layout in FIG. 11 is merely an example, and the present invention is not limited thereto.

The following two reasons are conceivable for displaying a frequency spectrum in which a frequency range is widened and two frequency spectra are superimposed.

In terms of vibration, at low frequencies, the displacement amount of the inspection target is large, and thus it is easy to determine the vibration.

At high frequencies, the displacement amount of the inspection target is small, and thus it may be difficult to determine the vibration.

In terms of sound pressure, at low frequencies, it may be difficult to specify a place where noise is generated as the wavelength becomes longer.

At high frequencies, the wavelength is short, and thus it is easy to specify a place where the noise is generated.

That is, in the inspection target, the lower the frequency is, the easier it is to determine the vibration, and the higher the frequency is, the easier it is to specify a place where the noise is generated.

As described above, since the detectable ranges of a vibration and a sound pressure are different from each other, there may be a case where information of either the frequency spectrum of a vibration or the frequency spectrum of a noise is insufficient depending on each region of each frequency spectrum as in ranges Y1 and Y2 illustrated in FIG. 11.

For example, in Y1, a frequency spectrum SP3 of the vibration is present, but the information of a frequency spectrum SP4 of the noise is insufficient.

For example, in Y2, a frequency spectrum SP4 of the noise is present, but the information of a frequency spectrum SP3 of the vibration is insufficient.

Thus, it is preferable that a place where the vibration or the noise can be specified even in frequency ranges (indicated as ranges Y1 and Y2) outside a range Z in which the frequency spectra of the frequency spectrum SP3 of the vibration and the frequency spectrum SP4 of the noise overlap each other.

The inspection target 9 may have peaks of the vibration level or the sound pressure level in the ranges Y1 and Y2.

As illustrated in FIG. 11, in an example according to the present embodiment, peaks of the sound pressure level are seen on a high frequency side (range Y2), and peaks of the vibration level are seen on a low frequency side (range Y1).

When generating the analysis image D7 (see FIG. 8), the analysis image generation unit 113 according to the present embodiment displays a frequency spectrum in a frequency range including SP3 and SP4 in consideration of a possibility that peaks of the vibration level or the sound pressure level may be present in the range Y1 or Y2.

FIG. 12 is a second diagram for explaining a function of the analysis device according to the third embodiment of the present disclosure.

The user designates a peak of the vibration level or the sound pressure level from the frequency spectrum displayed by the analysis image generation unit 113.

The analysis image generation unit 113 additionally displays an image related to a peak of the frequency spectrum designated together with the frequency spectrum.

For example, when a peak P4b of SP4 is designated in the range Z in which the frequency spectra of SP3 and SP4 overlap, only one first natural vibration frequency f3e at which a peak P3e of the vibration level appears is included within a predetermined range S around a second natural vibration frequency f4b.

In this case, since only one first natural vibration frequency is extracted in step S14, the analysis image generation unit 113 additionally displays one analysis image D7 in which the sound source image D6 is superimposed on the vibration image D4 corresponding to this first natural vibration frequency at f4b.

When the peak P3e of SP3 is designated, and when there is an analysis image D7 related to the vibration image D4 corresponding to the first natural vibration frequency f3e, the analysis image generation unit 113 additionally displays the analysis image D7.

Similarly, when a peak P4d of SP4 is designated in the range Z in which the frequency spectra of SP1 and SP2 overlap, first natural vibration frequencies f3h, f3i, and f3j at which peaks (P3h, P3i, and P3j) of the vibration level appear are included within a predetermined range T around a second natural vibration frequency f4d.

In this case, since a plurality of first natural vibration frequencies is extracted in step S14, the analysis image generation unit 113 additionally displays a plurality of analysis images D7 in which the sound source image D6 is superimposed on each of the vibration images D4 corresponding to the first natural vibration frequencies at f4d.

When the peak P3h, P3i, or P3j of SP3 is designated, and when there is a plurality of analysis images D7 related to each of the vibration images D4 corresponding to the first natural vibration frequencies (f3h, f3i, and f3j), the analysis image generation unit 113 additionally displays the analysis images D7.

When a peak P3c of SP3 is designated in the range Z in which the frequency spectra of SP3 and SP4 overlap, and when there is no analysis image D7 related to a vibration image D4 corresponding to a first natural vibration frequency f3c, the analysis image generation unit 113 additionally displays the vibration image D4.

The same applies to the case where P3d, P3f, or P3g is designated.

When a peak P4a of SP4 is designated in the range Z in which the frequency spectra of SP3 and SP4 overlap, no analysis image D7 is additionally displayed when there is no peak of the vibration level in a predetermined range around a second natural vibration frequency f4a.

The analysis image generation unit 113 additionally displays the sound source image D6.

The same applies to the case where P4c, P4e, P4f, or P4g is designated.

In addition, when n times a certain first natural vibration frequency is included within a predetermined range of the second natural vibration frequency f4a, the analysis device 10 can additionally display an analysis image D7 representing a candidate for the vibration causing the noise related to the certain first natural vibration frequency and the second natural vibration frequency f4a.

In this case, the user may set whether to display the analysis image D7 representing the candidate.

When an arbitrary natural vibration frequency is designated in the range Y1 or Y2 in which the frequency spectra of SP3 and SP4 do not overlap, the analysis image generation unit 113 additionally displays the following image together with the frequency spectrum.

When a peak P3a or P3b of SP3 is designated, and when no peak of SP4 is present in the range Y1, the analysis image generation unit 113 additionally displays the vibration image D4.

When the peak P4e, P4f, or P4g of SP4 is designated, and when no peak of SP1 is present in the range Y2, the analysis image generation unit 113 additionally displays the sound source image D6.

In addition, in an example according to the present embodiment, when a wide frequency range is displayed and thereby n times a first natural vibration frequency at which a peak of SP3 is present in the range Y1 is included in a predetermined range of any second natural vibration frequency, it is also possible to generate an analysis image D7 representing a candidate for the vibration causing the noise which is related to the first natural vibration frequency and the second natural vibration frequency.

Accordingly, the analysis device 10 can provide the user with a frequency spectrum having a wide frequency range and an image related to peaks of the frequency spectrum.

When a peak of the vibration level or the sound pressure level is observed within a range in which the frequency spectra of a vibration and a noise do not overlap, the user can estimate the cause of the noise or the vibration with reference to an image related to the peak.

Some embodiments according to the present disclosure have been described as above, these embodiments are presented as examples only, and are not intended to limit the scope of the invention.

These embodiments may be implemented in various other forms, and various omissions, substitutions, and changes can be made without departing from the gist of the invention.

These embodiments and modifications thereof are included in the scope and gist of the invention and are also included in the scope of the invention described in the claims and the equivalents thereof.

### Supplementary Notes

The analysis device, the analysis method, and the program described in the above-described embodiments are understood as follows, for example.

(1) According to a first aspect of the present disclosure, an analysis device (10) includes: a vibration image generation unit (110) configured to acquire, based on an image in which an inspection target (9) is photographed, vibration information including a time series of a vibration level of the inspection target (9) and a distribution of the vibration level for an individual vibration frequency and generate a vibration image visualizing the vibration level per region of the inspection target (9) on the image at a first natural vibration frequency at which a peak of the vibration level appears; a sound source image generation unit (111) configured to acquire, based on recorded sound data of the inspection target (9) recorded simultaneously with the image, noise information including a time series of a sound pressure level of a noise generated from the inspection target (9) and a distribution of the sound pressure level for the individual vibration frequency and generate a sound source image visualizing the sound pressure level per region on the image; an extraction unit (112) configured to extract, based on the vibration information and the noise information, the first natural vibration frequency included within a predetermined range from a second natural vibration frequency at which a peak of the sound pressure level of the noise appears; and an analysis image generation unit (113) configured to generate an analysis image in which the vibration image corresponding to the first natural vibration frequency extracted and the sound source image are superimposed.

With such a configuration, the analysis device can provide a user with the analysis image in which the correlation between the intensities of a vibration and a noise, the correlation between a vibration position and a sound source position of the noise, and the like can be visually recognized.

In addition, since the user can easily estimate a vibration causing the noise with reference to the analysis image, the user can appropriately take measures against the noise at an early stage.

(2) According to a second aspect of the present disclosure, in the analysis device (10) according to the first aspect, the extraction unit (112) extracts a plurality of the first natural vibration frequencies included in a predetermined range from the second natural vibration frequency, and the analysis image generation unit generates a plurality of the analysis images corresponding to the respective plurality of the first natural vibration frequencies.

Accordingly, when there is a plurality of vibration modes (first natural vibration frequencies) close to the second natural vibration frequency of the noise, the analysis device can generate the analysis image of each vibration mode.

In addition, even when only one vibration causing the noise cannot be selected from the natural vibration frequencies, the user can accurately estimate a vibration causing the noise by confirming the correlation between the vibration position and the sound source position of the noise in the analysis image.

(3) According to a third aspect of the present disclosure, in the analysis device (10) according to the first or second aspect, when a vibration frequency in which is the first natural vibration frequency is multiplied by a predetermined number is included within the predetermined range from the second natural vibration frequency, the extraction unit (112) extracts the first natural vibration frequency.

Accordingly, the analysis device can generate the analysis image representing a candidate for the vibration causing the noise in consideration of a possibility that the noise is generated at a period which is a predetermined multiple of the vibration.

(4) According to a fourth aspect of the present disclosure, the analysis device (10) according to any one of the first to third aspects further includes an estimation unit (114) configured to estimate a vibration causing the noise based on the analysis image.

Accordingly, the analysis device can enable the user to recognize the vibration estimated as the cause of the noise.

In addition, even when a plurality of analysis images is generated, the analysis device can provide the user with the analysis image corresponding to the vibration estimated as the cause, whereby the user can reduce the time and effort for checking all the analysis images.

(5) According to a fifth aspect of the present disclosure, in the analysis device (10) according to the fourth aspect, when a distance between a region in which the sound pressure level is largest and a region in which the vibration level is largest in the analysis image is equal to or less than a threshold value, the estimation unit (114) estimates that a vibration at the first natural vibration frequency indicated by the analysis image is a cause of the noise.

Accordingly, the analysis device can accurately estimate that the vibration in the analysis image is the cause of the noise from the correlation between the vibration position and the sound source position indicated by the analysis image.

(6) According to a sixth aspect of the present disclosure, in the analysis device (10) according to the fourth or fifth aspect, when a distance between a region in which the sound pressure level is largest and a region in which the vibration level is largest in the analysis image exceeds a threshold value, the estimation unit (114) estimates that a vibration at the first natural vibration frequency indicated by the analysis image is not a cause of the noise.

Accordingly, the analysis device can accurately estimate that the vibration in the analysis image is not the cause of the noise from the correlation between the vibration position and the sound source position indicated by the analysis image.

(7) According to a seventh aspect of the present disclosure, in the analysis device (10) according to the first or sixth aspect, the analysis image generation unit (113) superimposes and displays frequency spectra of a vibration and a noise on common axes and displays an image related to a peak of the frequency spectra designated.

Accordingly, the analysis device can provide the user with a frequency spectrum having a wide frequency range and an image related to a peak of the frequency spectrum.

The inspection target may have a peak of the vibration level or the sound pressure level in a range in which the frequency spectra of the vibration and the noise do not overlap.

The user can estimate a cause of a noise or a vibration with reference to the frequency spectrum and the image related to the peak of the frequency spectrum even in a range in which the frequency spectra of the vibration and the noise do not overlap.

(8) According to an eighth aspect of the present disclosure, an analysis method includes: acquiring, based on an image in which an inspection target (9) is photographed, vibration information including a time series of a vibration level of the inspection target (9) and a distribution of the vibration level for an individual vibration frequency and generating a vibration image visualizing the vibration level per region of the inspection target (9) on the image at a first natural vibration frequency at which a peak of the vibration level appears; acquiring, based on recorded sound data of the inspection target (9) recorded simultaneously with the image, noise information including a time series of a sound pressure level of a noise generated from the inspection target (9) and a distribution of the sound pressure level for the individual vibration frequency and generating a sound source image visualizing the sound pressure level per region on the image; extracting, based on the vibration information and the noise information, the first natural vibration frequency included within a predetermined range from a second natural vibration frequency at which a peak of the sound pressure level of the noise appears; and generating an analysis image in which the vibration image corresponding to the first natural vibration frequency extracted and the sound source image are superimposed.

(9) According to a ninth aspect of the present disclosure, a program causes an analysis device to execute: acquiring, based on an image in which an inspection target (9) is photographed, vibration information including a time series of a vibration level of the inspection target (9) and a distribution of the vibration level for an individual vibration frequency and generating a vibration image visualizing the vibration level per region of the inspection target (9) on the image at a first natural vibration frequency at which a peak of the vibration level appears; acquiring, based on recorded sound data of the inspection target (9) recorded simultaneously with the image, noise information including a time series of a sound pressure level of a noise generated from the inspection target (9) and a distribution of the sound pressure level for the individual vibration frequency and generating a sound source image visualizing the sound pressure level per region on the image; extracting, based on the vibration information and the noise information, the first natural vibration frequency included within a predetermined range from a second natural vibration frequency at which a peak of the sound pressure level of the noise appears; and generating an analysis image in which the vibration image corresponding to the first natural vibration frequency extracted and the sound source image are superimposed.

### INDUSTRIAL APPLICABILITY

According to the aspect described above, it is possible to visualize the correlation between the sound source of the noise and the vibration of the inspection target.

### REFERENCE SIGNS LIST

1 Analysis system
2 Camera
3 Microphone
9 Inspection target
10 Analysis device
11 Processor
110 Vibration image generation unit
111 Sound source image generation unit
112 Extraction unit
113 Analysis image generation unit
114 Estimation unit
12 Memory
13 Storage
14 Communication interface
15 Display device
16 Input device

1. An analysis device, comprising:
a vibration image generation unit configured to acquire, based on an image in which an inspection target is photographed, vibration information including a time series of a vibration level of the inspection target and a distribution of the vibration level for an individual vibration frequency and generate a vibration image visualizing the vibration level per region of the inspection target on the image at a first natural vibration frequency at which a peak of the vibration level appears;
a sound source image generation unit configured to acquire, based on recorded sound data of the inspection target recorded simultaneously with the image, noise information including a time series of a sound pressure level of a noise generated from the inspection target and a distribution of the sound pressure level for the individual vibration frequency and generate a sound source image visualizing the sound pressure level per region on the image;
an extraction unit configured to extract, based on the vibration information and the noise information, the first natural vibration frequency included within a predetermined range from a second natural vibration frequency at which a peak of the sound pressure level of the noise appears; and
an analysis image generation unit configured to generate an analysis image in which the vibration image corresponding to the first natural vibration frequency extracted and the sound source image are superimposed.

2. The analysis device according to claim 1, wherein
the extraction unit extracts a plurality of the first natural vibration frequencies included in the predetermined range from the second natural vibration frequency, and
the analysis image generation unit generates a plurality of the analysis images corresponding to the respective plurality of the first natural vibration frequencies.

3. The analysis device according to claim 1, wherein when a vibration frequency in which the first natural vibration frequency is multiplied by a predetermined number is included within the predetermined range from the second natural vibration frequency, the extraction unit extracts the first natural vibration frequency.

4. The analysis device according to claim 1, further comprising an estimation unit configured to estimate a vibration causing the noise based on the analysis image.

5. The analysis device according to claim 4, wherein when a distance between a region in which the sound pressure level is largest and a region in which the vibration level is largest in the analysis image is equal to or less than a threshold value, the estimation unit estimates that a vibration at the first natural vibration frequency indicated by the analysis image is a cause of the noise.

6. The analysis device according to claim 4, wherein when a distance between a region in which the sound pressure level is largest and a region in which the vibration level is largest in the analysis image exceeds a threshold value, the estimation unit estimates that a vibration at the first natural vibration frequency indicated by the analysis image is not a cause of the noise.

7. The analysis device according to claim 1, wherein the analysis image generation unit superimposes and displays frequency spectra of a vibration and a noise on common axes and displays an image related to a peak in the frequency spectra designated.

8. An analysis method, comprising:
acquiring, based on an image in which an inspection target is photographed, vibration information including a time series of a vibration level of the inspection target and a distribution of the vibration level for an individual vibration frequency and generating a vibration image visualizing the vibration level per region of the inspection target on the image at a first natural vibration frequency at which a peak of the vibration level appears;
acquiring, based on recorded sound data of the inspection target recorded simultaneously with the image, noise information including a time series of a sound pressure level of a noise generated from the inspection target and a distribution of the sound pressure level for the individual vibration frequency and generating a sound source image visualizing the sound pressure level per region on the image;
extracting, based on the vibration information and the noise information, the first natural vibration frequency included within a predetermined range from a second natural vibration frequency at which a peak of the sound pressure level of the noise appears; and
generating an analysis image in which the vibration image corresponding to the first natural vibration frequency extracted and the sound source image are superimposed.

9. A non-transitory computer-readable recording medium storing a program causing an analysis device to execute:
acquiring, based on an image in which an inspection target is photographed, vibration information including a time series of a vibration level of the inspection target and a distribution of the vibration level for an individual vibration frequency and generating a vibration image visualizing the vibration level per region of the inspection target on the image at a first natural vibration frequency at which a peak of the vibration level appears;
acquiring, based on recorded sound data of the inspection target recorded simultaneously with the image, noise information including a time series of a sound pressure level of a noise generated from the inspection target and a distribution of the sound pressure level for the individual vibration frequency and generating a sound source image visualizing the sound pressure level per region on the image;
extracting, based on the vibration information and the noise information, the first natural vibration frequency included within a predetermined range from a second natural vibration frequency at which a peak of the sound pressure level of the noise appears; and
generating an analysis image in which the vibration image corresponding to the first natural vibration frequency extracted and the sound source image are superimposed.
